(19) United States
(12) Patent Application Publication
(10) Pub. No.: US 2010/0085350 A1
(43) Pub. Date: Apr. 8, 2010

(54) OBLIQUE DISPLAY WITH ADDITIONAL DETAIL

(75) Inventors: Pragyana K. Mishra, Kirkland, WA (US); Eyal Ofek, Redmond, WA (US); Gur Kimchi, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/244,435

(22) Filed: Oct. 2, 2008

(51) Int. Cl. G06T 15/00

(52) U.S. Cl. 345/419

(57) ABSTRACT

A method and system of creating an oblique display with additional detail such as texture and labels is disclosed. The footprint of objects on the image on a digital elevation map may be determined and an outline of the objects may be determined by creating object polygons that outline the bounds of the objects. The objects that are visible in the image and the objects that are occluded are determined using the footprint of the objects and the object polygons. The occluded object sections may be displayed in a modified form as part of the occluding object. Label display locations may be evaluated for objects to determine an optimal label display location based on a label criteria function and labels may be added to the objects in the image at the optimal label display location.

### BACKGROUND

This Background is intended to provide the basic context of this patent application and it is not intended to describe a specific problem to be solved.

Trying to create a useful but easy to view illustration of a large sphere such as the Earth has long been a challenge. As a sphere is curve, tradition methods may be forced to bend of stretch parts of the illustration. In addition, traditional top down illustrations are not especially useful as top of buildings are rarely recognizable but such illustrations provide a useful way to see street and other thoroughfares. Street level illustration often provide great detail of the facades of buildings but often contain too much detail and do not provide an overall view that users often need in understanding a layout of a city. In addition, stitching together a plurality of illustrations to have a continuous view of the sphere has led to additional challenges as connecting a plurality of flat images of a round surface has been difficult.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method and system of creating an oblique display with additional detail such as building texture is disclosed. In one embodiment of the method, an image is created from an image origin where the image origin has an image center, a fixed height and a fixed oblique angle. The footprint of objects on the image on a digital elevation map may be determined. An outline of the objects may be determined by creating object polygons where the object polygons outline the bounds of the objects. The objects that are visible in the image are determined using the footprint of the objects and the object polygons. The location of occluded object sections may be determine where occluded object sections may be sections of objects of interest that are occluded by occluding objects in the oblique view. The occluded object sections may be displayed in a modified form as part of the occluding object. Label display locations may be evaluated for objects to determine an optimal label display location based on a label criteria function and labels may be added to the objects in the image at the optimal label display location.

### BRIEF DESCRIPTION OF THE DRAWINGS

FIG. 1 is an illustration of a computing device;

FIG. 2 is an illustration of a method of creating a hybrid oblique mapping image;

FIG. 3 is an illustration of an image of a traditional two-dimensional overhead view map;

FIG. 4 is an illustration of a hybrid oblique map indicating positions of different elements in the image of FIG. 3; and

FIG. 5 is an illustration of the different oblique angles that may be used to create an oblique map.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

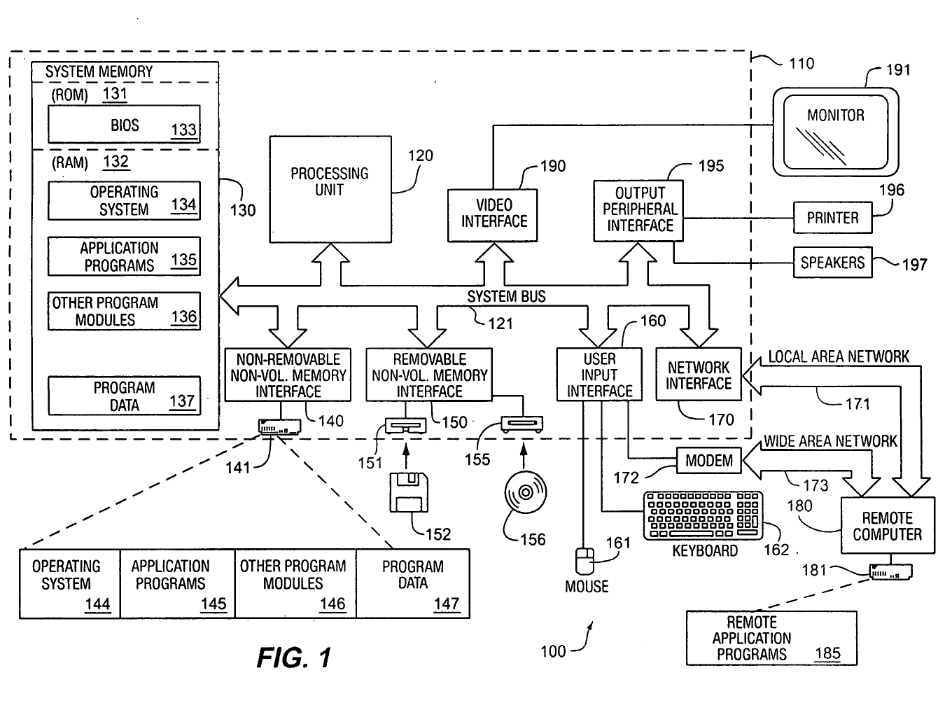

FIG. 1 illustrates an example of a suitable computing system environment 100 that may operate to display and provide the user interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to a optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

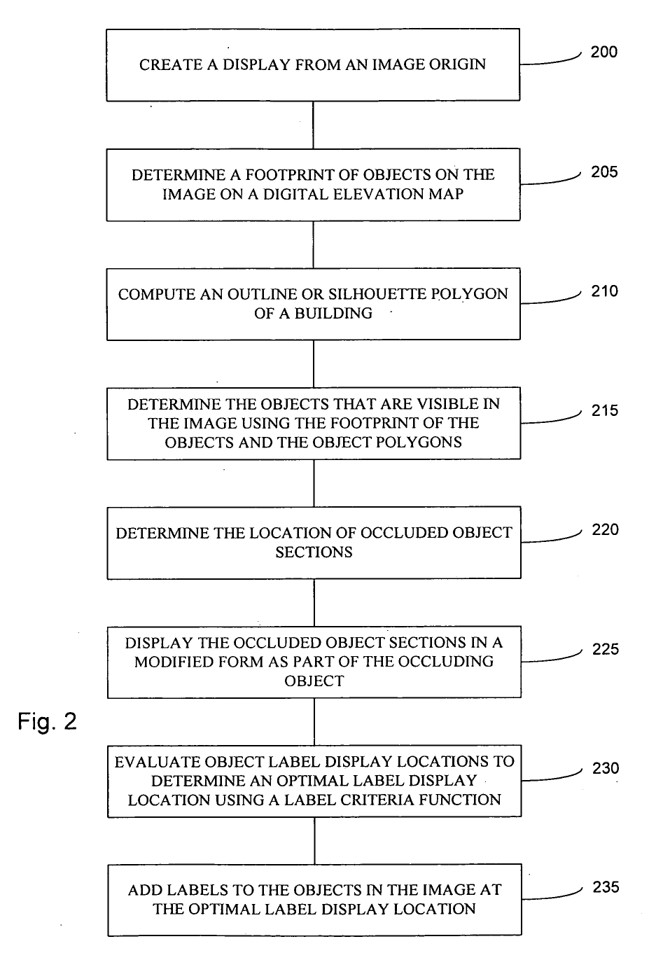

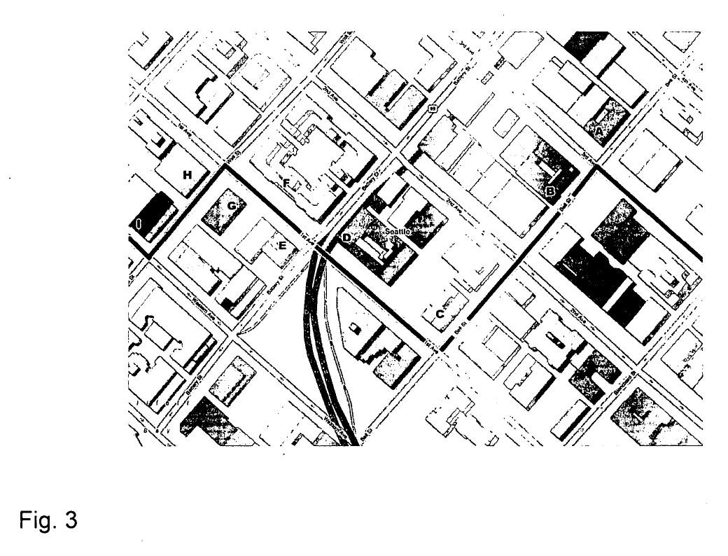

FIG. 2 may illustrate a method of creating an oblique display with additional detail that may be implemented using a computing system such as the computing system described in regard to FIG. 1. Traditional maps such as in FIG. 3, both online and on paper, show geospatial information in a top-down orthographic view of the world. This is an abstract, albeit simplistic and comprehensive, representation of geospatial entities such as streets, roads, landmarks, geographical entities and boundaries. This abstract representation has little visual correlation to views as observed by a viewer on ground level. On the other hand, any attempt to represent geospatial information using street-level imagery cannot have a wide coverage or be comprehensive in showing mapping information over a large area or multiple street segments.

Street-level imagery, that is a collection of images of all the houses and objects along the streets and road on an area, is a great source of information shown from a point of view of the common user. However browsing such large amount of information (A typical city might be covered by tens of millions of images), is problematic. A paradigm that combines the comprehensiveness of top-down orthographic view of traditional maps with the realism of street-level views is the Hybrid Oblique mapping paradigm that is described herein.

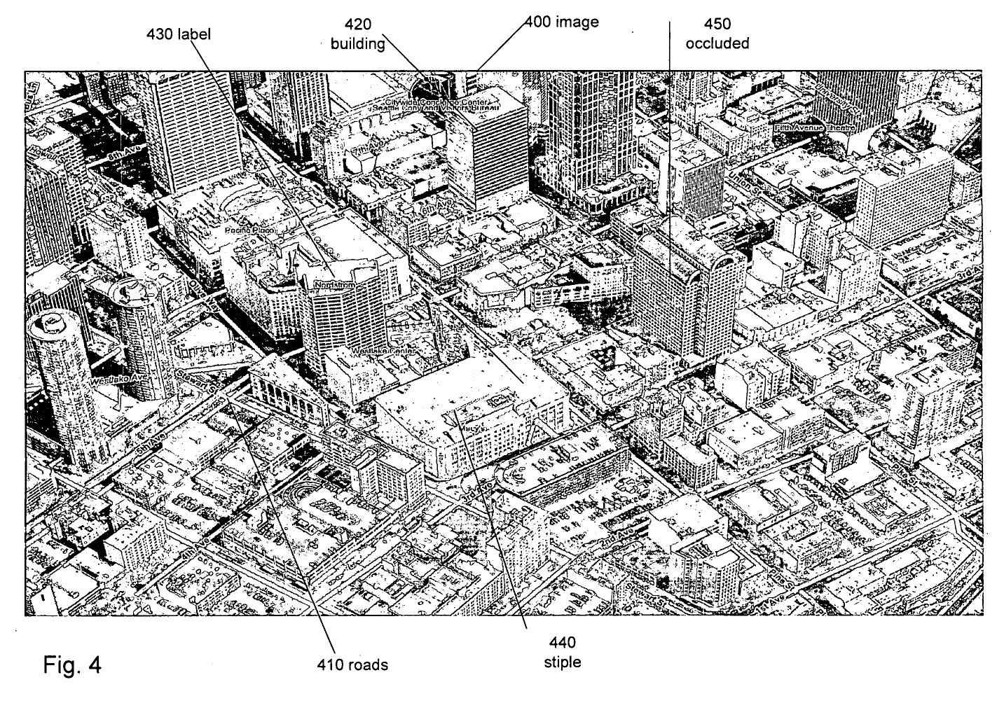

Oblique images 400 such as in FIG. 4 are aerial images taken at oblique angles to the ground. Taking images at oblique angles allows side views of buildings and structures to be clearly observed. These images, such as those served as “Bird's Eye” images on Microsoft's® Virtual Earth™, combines the relatively-large coverage of aerial images, with realistic views of buildings and structures facades that correlate well to what users see at street level. What makes these images more interesting is that they capture the 3-dimensional nature of earth's surface and structures such as buildings and highways. For example, straight roads that are on the slope of a hill will appear curved and the relative height of buildings may be determined by simply viewing the image 400.

When trying to use oblique images as a base for a mapping application, there are several difficulties:

1. A map is a representation of the world under some fixed geometrical mapping. The mapping projects 3-D points in space to the 2-D image of the map. Each bird's eye or oblique image is a projective image taken from a different point of view; therefore, there is a unique mapping from the real world for each image. This makes the navigation between the images complex and difficult, as each image is viewed from a different direction (in contrast to a map that can be endlessly scrolled along the Earth's surface).

2. Mapping between a point on the map and the earth is a non-linear function that depends on the elevation of the Earth; it is not a simple function unlike a regular scale function used in traditional maps.

3. Perspective effects also depend on the viewing direction of the scene. Since the viewing direction is at an oblique angle to the surface of the earth, other view-dependent factors such as occlusions and the relationship between building footprints and heights. All of these effects make oblique images a more information-rich mapping medium. Annotating these images necessitates the use of digital-elevation-maps (DEMs) to accurately project the 3-dimensional points of roads and structures onto images and then annotating them with labels. The labels and markings may annotate the pixel areas corresponding to roads and structures. Annotations also have to account for occlusions and heights of buildings. For example, a road label that appears occluded by a tall building cannot be placed on the building itself.

To overcome these problems, a new mapping mode has been created and described herein: the Hybrid Oblique Paradigm. The term “Hybrid” represents the fact that this mode is a combination of a photo-realistic imaging, which facilitates easy recognition, and graphic meta-data, such as a road network.

The model is leverage on models of the Earth's terrain and buildings to enable this paradigm. Of course, another sphere, planet or surface may use the model. Models, textured by projecting the original oblique images, enable new views of the Earth to be generated. A continuous view of the Earth may be generated from a fixed inclination angle, with a fixed horizontal scale. The view combines the photo-realistic nature of the original photos, with a map-like surface, that can be scrolled continually, and support one fixed mapping from the world to the map, and one that maps from the map to the world (although this mapping direction requires the knowledge of the Earth elevation data).

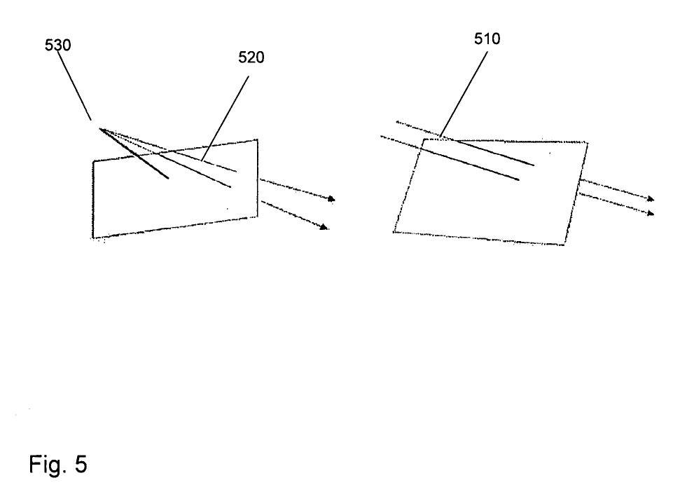

The described annotation scheme brings out the 3-dimensional nature of oblique images by marking occluded roads with stippled lines 500 (FIG. 5) and placing road labels on visible parts of roads 510. Road that are completely occluded in a scene may be marked differently, such as with stippled lines and are labeled sparsely that accounts for occlusions. Labeling of structures such as landmark buildings, on the other hand, may to appear on the structures 520. Placement of labels is, therefore, done by optimizing for occlusions, view dependency of scenes, label collisions, and perspective effects. Hybrid Oblique combines disparate data sources such as DEM, vector data, aerial imagery, and 3D models to generate mapping applications through placement of labels and annotations in a way that a user can easily relate to in the real world. Of course, other annotation schemes are possible and are contemplated.

A Hybrid Oblique map 400 may illustrate map information by labeling real images of the world with vector data. These real images are taken at oblique angles to the earth's surface from an aerial camera such that the image covers a wide expanse of the environment. Hybrid Oblique maps 400 capture the spatial arrangement of geospatial entities such as roads and buildings, and also views of those entities close to what is observed by users at street level. This is a unique way of combining abstract vector maps with realistic views of scenes to which users can easily relate.

As Bird's Eye images are taken at oblique angles as opposed to the top-down orthographic view of satellite images (such as in FIG. 3), oblique views better capture the 3-dimensional nature of earth's terrain and physical structures such as buildings and highways. Additionally, these images have perspective effects that depend on the viewing direction of the scene. Other view-dependent factors such as occlusions and the relationship between building footprints and heights convey more spatial information than traditional maps.

Generating Hybrid Oblique maps 400 may requires the use of digital-elevation-maps (DEMs) to accurately project the 3-dimensional points of roads 410 and structures 420 onto images and then annotating them with labels or annotations 430. The labels, annotations and markings 430 may annotate the pixel areas corresponding to roads 410 and structures 420. Annotations 430 may also have to account for occlusions and heights of buildings 420. For example, a label 430 for a road 410 that appears occluded by a tall building 420 cannot be placed on the building 420 itself as this may confuse a user into thinking the building 420 has the same name as the road 410. This annotation scheme brings out the 3-dimensional nature of oblique images by marking occluded roads 410 with stippled lines 440 and placing labels 430 on visible parts of roads 410. Roads 410 that are completely occluded 450 in a scene are also marked with stippled lines 440 and are labeled sparsely. Labeling of structures 420 such as landmark buildings, on the other hand, have to appear on the structures.

Placement of labels 430 may, therefore, be accomplished by optimizing for occlusions 450, view dependency of scenes, label collisions, and perspective effects. Hybrid Bird's Eye or Oblique Maps 400 combine disparate data sources such as DEM, vector data, aerial imagery, and 3D models to generate mapping applications through placement of labels and annotations in a way that a user easily relates to in the real world.

There may be a variety of oblique views of the same object. For example, the building 430 may be viewed from a North, South, West and East oblique angle. Of course, additional views, oblique angles and heights are possible. Additional detail may be virtual any detail desired by an application or a user. Some users may be interested in street names. Other users may be interested in building names. Still other users may be curious of the architects of various buildings. Other users may only want to know about golf courses. The additional detail may be as wide and varied as people and their interests.

Referring to FIG. 2, at block 200, the display 400 may be created from an image origin. The image origin may include an image center, a fixed height and a fixed oblique angle. In one embodiment, the image 400 is created with a camera mounted on an aircraft or satellite. In this embodiment, the image center would be a lens of the camera.

In one embodiment, the image 400 may be rendered using a fixed x scale and a fixed y scale. The scales may be different or the same. By keeping the scales fixed, the relative size of different objects such as building 420 and roads 410 in the image 400 may be compared. The scales may be set automatically or may be adjustable by a user or an application. Varying scales are possible and may be adjusted by the user or by an application.

The image 400 may depend on the slope or the terrain of the earth's surface. Digital elevation maps and 3-d building models may be used to determine the areas of projection corresponding to buildings, roads, and other geospatial entities onto the image as in the display 400. Digital elevation maps are publicly available such as from the United States Government or from Microsoft's online mapping product, Virtual Earth. The slope of the terrain determines the curve of a road or of the elevation of the base of buildings. The additional block may further clarify the creation of the hybrid oblique display 400.

At block 205, the footprint of objects such as a building 420 on the image 400 on a digital elevation map may be determined. Camera parameters of an oblique image are used for calculating the footprint of the image onto a digital elevation map. The footprint may determine the physical extent of the area in the image 400 (such as of the Earth surface) that is covered by the oblique image 400. Rays emanating from the camera's optical center through the four corners of the image or display 400 are intersected with the digital elevation map. The intersection points with the digital elevation map may determine the area that is covered by the image. The footprint of the image 400 may be created from the projected area by padding it with extra regions on all sides, which accounts for any partially visible buildings 420 or structures in the image 400.

The footprint may determine what structures such as (and not limitation) roads 410, landmarks, and buildings 420 are visible in the oblique image 400. A database of vector data may be queried for names of roads 410 and road geometry, names and positions of landmarks and structures 420 that fall within the bounds of this footprint. A list of other relevant data such as roads names, road type (limited access highway, controlled access highway, major, arterial, street), and road geometry may be generated from this query. Additional landmarks or prominent buildings may include parks, golf courses, schools, public libraries, and other physically-distinct entities. These additional landmarks may be stored in the same list or in a separate list which may have the name of the entity and its position in terms of latitude and longitude.

Road geometry may be encoded as a set of latitude-longitude pairs for each road segment where each road consists of a set of connected straight segments. Roads may be projected onto the oblique image 400 using the road geometry, digital elevation maps, and the camera projection matrix corresponding to that image. Each road 410 segment may be marked on the oblique image 400 as a line and the line color may be determined by the road type.

After the roads geometries are marked, parts of the roads 410 that are occluded by buildings 420 may be determined. Three dimensional building models may be projected onto the oblique image 400 using the building geometry and the camera projection matrix.

At block 210, once a building 420 is projected onto the image 400, its outline or silhouette may be computed and this outline is a polygon that should bound the entire visible building. Applications exist that identify and outline buildings 420 and virtually any of these applications are appropriate. In addition, a user may be given the opportunity to review the outline polygon and make adjustments to improve or focus the image 400 on the elements 410, 420 of interest to the user. The outline polygon may be used for label 430 placement.

At block 215, the objects such as road 410 and buildings 420 that are visible in the image 400 may be determined using the footprint of the objects 410, 420 and the object polygons. In implementation, the pixels that are inside the polygon may be identified and stored. In one embodiment, the oblique image 400 is used to identify the visible objects 410, 420 as the visible objects 410, 420 are visible in the oblique image 400.

Related, at block 220, the location of occluded object sections 450 may be determined. Occluded object sections 450 may contain sections of objects of interest such as roads 410 and building 420 that are occluded by occluding objects in the oblique view 400. For example, a road 410 that progresses behind a building 420 usually would be blocked by the building 420. In implementation, the pixels that are used for illustrating the road 410 may be a subset of the pixels from block 215 (pixels inside the polygon that represent the road 410) that indicate a building 420 is present in front of the road 410. If there is a match, the pixels that are for a road 410 and inside the polygon may be occluded.

Roads 410 may be projected onto the oblique display using the road geometry, the digital elevation maps, and an image origin matrix. Road 410 geometry may include a set of latitude-longitude pairs for each road segment and each road comprises a set of connected straight segments. Curves may be a series of straight road 410 segments connected together.

At block 225, the occluded object sections may be displayed in a modified form as part of the occluding object 450. Road 410 segments that lie within the building-silhouette polygons may be indicated in a different manner, such as being stippled 440. The stippling may maintain continuity of the road segment occluded by a building as well as bring out the 3-D nature of oblique images. In this way, any possible confusion between the name of buildings and name of roads will be minimized.

At block 230, label 430 display locations for objects may be evaluated to determine an optimal label display location based on label criteria function. The label criteria function may have a variety of different variables and constraints, some of which may be maximized and some of which may be minimized.

To create optimal display locations, an initial estimate of the position of the labels 430 for roads 410 may be calculated. This calculation takes into account that the label 430 for a road 410 can lie anywhere on a road 410 segment with an orientation that is tangential to the road 410 at that point. The label 430 for the road 410 also cannot lie within a silhouette polygon because we don't want to label a road 410 at a place where it is occluded by a building 420. This optimization for the placement of labels 430 also takes into account label collision, oblique image tile size, proximity to road intersections, same-entity label frequency, and foreshortening. Label 430 collision ensures that two labels 430 cannot collide or intersect.

The oblique image 400 tile size considers the fact that a large oblique image may be made up of a set of smaller tiles and that labels 430, wherever possible, do not span across multiple tiles. Same entity-label frequency determines the number of times a single road 410 is labeled in an image 400. For example, a long road 410 such as 3^{rd} Avenue in the image 400 has to have a label 430 at regular intervals to maintain continuity of labeling. A road 410 that is occluded by a wide building 420 and is, therefore, fragmented may have to have a label 430 at both sides of the building 420. For example, the label criteria function for objects that are roads 410 may at least one constraint selected from a group constraints such as:

Labels 430 may lie anywhere on a road 410 segment with an orientation that is tangential to the road 410 at that point;

Labels 430 for roads 410 cannot lie within the object polygon;

The label 430 cannot be displayed over another label 430;

It is preferable to display a label 430 for a road 410 near road intersections;

A label 430 should not be repeated too close to another instant of the same label 430;

It is desirable to keep a label 430 inside a single image 400;

It is desirable to add a label 430 a continuous roads 410 as consistent intervals;

It is desirable to add a label 430 to a road on both sides of a large occlusion 450;

The labels 430 of buildings 420 may also be optimally placed. For example, the labels 430 may be placed within the corresponding building 420 silhouettes in a manner that they do not collide with other labels 430. A preference of placing labels 430 on buildings 420 at the top parts of buildings on the oblique image 400 may necessitate that an initial guess for labels 430 for a building 420 starts at the building 420 rooftop. Different variables and constraints may be used for buildings 420. Some sample constraints may be as follows:

Labels 430 should be near tops of buildings 420;

Labels 430 should not be placed on the tops of buildings 420;

Labels 430 should not be displayed over other labels 430; and

Labels 430 should fit within the object polygons.

At block 235, labels 430 may be added to the objects in the image 400 at the optimal label display location. The labels 430 may be for roads 410, buildings 420 or other object that is desired to be labeled. The labels 430 may be aligned for roads 420 with images by accounting for slope of image surface. In one embodiment, labels 430 are placed on an overlay wherein the overlay comprises a transparent image that is the same size as the image 400. This overlay when superimposed on an oblique image 400 may produce a composite where all labels 430 and markings exactly correspond to the image areas underneath. The composite image may be the hybrid oblique image 400.

As mentioned previously, there may be a plurality of selectable different perspectives of the same image 400. For example, the same element may be viewed from an oblique angle from the North, the South, the East and the West. The images 400 may be created in the same manner as the image 400 described previously, but just have the perspective from a different origin.

The above process may be used to generate a hybrid oblique image 400 that is taken from a single point of view. The method may also be used to generate a continuous map layer of the Earth's surface at an oblique angle. Such a layer can be browsed by users as they scroll on a seemingly-endless image 400, the same way Virtual Earth™ users browse the orthographic (aerial or satellite) map layer today. The various tiles of hybrid oblique images may be “stitched” together in virtually any appropriate manner and the continuous oblique map may be created on any object, including the Earth. As a result, an improved view and vision of an area may be created in that both streets and the faces of buildings may be viewed from a single illustration. Further, as this view may be continuous, new applications may be created such as virtual hot air balloon trips through a city, improved flight simulators, etc.

The mapping from a 3D point on the Earth to the oblique map is represented by a simple, unified mapping function. Note that each original oblique image, which was used for generating the hybrid oblique map 400, may have its own projection mapping from the Earth to the image. There also may be one mapping function from the image to the Earth surface given the data of the Earth's elevation and 3D structure on it (A ray from the image is intersected with this model data to derive a 3D point).

To be able to generate this layer, 3-D models of the Earth terrain and buildings from the Virtual Earth 3-D database may be used. The 3-D models may be projected onto the image along with their texture. The textured models may be rendered under orthographic projection on the map. As illustrated in FIG. 5, the viewing rays 510 that originate at each pixel are parallel. This is in contrast to a regular projective image where the rays 520 intersect at the camera's focal point 530.

To create the continuous map, a pre-process may be used. In the pre-process, a model of the terrain and buildings textured by oblique images may be generated. The terrain may be traversed in a specific order such as a raster order from North to South and from West to East and tiles of the map may be generated. A tile is generated by fetching the terrain and models that fall within the footprint of that tile, and render them at a fixed oblique-viewing direction under orthographic projection. Each tile may be annotated as described with respect to blocks 200-235. As a result, in contrast to a perspective image, the roads remain parallel in the map projection and they do not converge in a vanishing point as usually visible in perspective images.

In conclusion, a map is created that illustrates road, buildings, slopes and the façade of buildings in a continuous fashion. Obtaining a feel for a city or obtaining driving directions through a city or area is improved as a result of the system and method as more relevant information is provided to a user in an easier to see format.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of creating an oblique display with additional detail comprising:
Creating an image from an image origin wherein the image origin comprises an image center, a fixed height and a fixed oblique angle;
Determining the projection of objects on the image using oblique display parameters, 3-dimensional models, and digital elevation maps;
Determining an outline of the objects by creating object polygons wherein the object polygons comprises an outline that bounds the objects;
Determining the objects that are visible in the image using the footprint of the objects and the object polygons;
Determining the location of occluded object sections wherein occluded object sections comprises sections of objects of interest that are occluded by occluding objects in the oblique view;
Displaying the occluded object sections in a modified form as part of the occluding object;
Evaluating label display locations for objects to determine an optimal label display location based on label criteria function; and
Adding labels to the objects in the image at the optimal label display positions.

2. The method of claim 1, further comprising rendering the image using a fixed x scale and a fixed y scale.

3. The method of claim 1, further comprising using digital elevation maps and 3-d building models to create slope in the image.

4. The method of claim 3, further comprising aligning labels for roads and streets with images by accounting for slope of terrain and relative position and orientation of display surface.

5. The method of claim 3, wherein the label criteria function for objects that comprises roads comprises at least one constraint selected from a group comprising:
Labels may lie anywhere on a road segment with an orientation that is tangential to the road at that point;
Road labels cannot lie within the object polygon;
The label cannot be displayed over another label;
It is preferable to display a road label near road intersections;
A label should not be repeated too close to another instant of the same label;
It is desirable to keep a label inside a single image;
It is desirable to label continuous roads as consistent intervals; and
It is desirable to label a road on both sides of a large occlusion.

6. The method of claim 3, wherein the label criteria function for objects that comprises buildings comprises at least one selected from a group comprising:
Names should be near tops of buildings;
Names should not be placed on the tops of buildings;
Names should not be displayed over other labels; and
Names should fit within the object polygons.

7. The method of claim 1, wherein labels are placed on an overlay wherein the overlay comprises a transparent image that is the same size as the image.

8. The method of claim 1, wherein determining the footprint of the objects further comprises projecting rays from a center of an image origin to four corner of the image.

9. The method of claim 1, wherein the image origin comprises a camera lens.

10. The method of claim 9, further comprising adding additional regions to the perimeter of the footprint to capture objects that are partially in the image.

11. The method of claim 1, wherein determining the footprint further comprises querying a database of vector data for relevant data related to the footprint.

12. The method of claim 11, wherein the relevant data comprises at least one selected from a group comprising:
name of roads;
road geometry;
road type;
landmark names;
landmark locations;
structure names;
structure locations;
parks;
golf courses;
tennis courts;
parking structures;
schools;
public libraries; and
other physically distinct objects.

13. The method of claim 1, wherein roads are projected onto the oblique display using the road geometry, the digital elevation maps, and an image origin matrix.

14. The method of claim 13, wherein road geometry comprises a set of latitude-longitude pairs for each road segment and wherein each road comprises a set of connected straight segments.

15. The method of claim 1, further comprising creating selectable different perspectives of the same image.

16. The method of claim 1, further comprising:
generating a model of the image terrain and buildings textured by oblique images;
traversing the terrain in a specific order and generating tile of the map wherein generating a tile comprises fetching the terrain and models that fall within the footprint of that tile; and
rendering the tiles at a fixed oblique viewing direction under orthographic projection.

17. The method of claim 16, further comprising arranging the hybrid oblique tiles for continuous movement and viewing of tiles and a resulting continuous hybrid oblique view of an area covered by the tiles.

18. A computer storage medium comprising computer executable code for creating an oblique display with additional detail, the computer code comprising code for:
Creating an image from an image origin wherein the image origin comprises an image center, a fixed height and a fixed oblique angle;
Determining the footprint of objects on the image on a digital elevation map;
Determining an outline of the objects by creating object polygons wherein the object polygons comprises an outline that bounds the objects;
Determining the objects that are visible in the image using the footprint of the objects and the object polygons;
Determining the location of occluded object sections wherein occluded object sections comprises sections of objects of interest that are occluded by occluding objects in the oblique view;
Displaying the occluded object sections in a modified form as part of the occluding object;
Evaluating label display locations for objects to determine an optimal label display location based on label criteria function;
Adding labels to the objects in the image at the optimal label display location;
Generating a model of the image terrain and buildings textured by oblique images;
Traversing the terrain in a specific order and generating tile of the map wherein generating a tile comprises fetching the terrain and models that fall within the footprint of that tile; and
Rendering the tiles at a fixed oblique viewing direction under orthographic projection.

19. The computer storage medium of claim 18, wherein the label criteria function for objects that comprise roads comprises at least one constraint selected from a group comprising:
Labels may lie anywhere on a road segment with an orientation that is tangential to the road at that point;
Road labels cannot lie within the object polygon;
The label cannot be displayed over another label;
It is preferable to display a road label near road intersections;
A label should not be repeated too close to another instant of the same label;
It is desirable to keep a label inside a single image;
It is desirable to label continuous roads as consistent intervals; and
It is desirable to label a road on both sides of a large occlusion.

20. The computer storage medium of claim 18, wherein the label criteria function for objects that comprise of buildings and comprises at least one selected from the following group:
Names should be near tops of buildings;
Names should not be placed on the tops of buildings;
Names should not be displayed over other labels; and
Names should fit within the object polygons.
